(19) United States
(12) Patent Application Publication
(10) Pub. No.: US 2013/0300818 A1
(43) Pub. Date: Nov. 14, 2013

(54) INTERACTIVE VIDEO PLATFORM SYSTEM AND METHOD FOR THE SAME

(71) Applicants: HSIN-CHIA FU, HSINCHU CITY (TW); CHENG-LUNG TSENG, HSINCHU COUNTY (TW); YUNG-CHANG TAI, KAOHSIUNG CITY (TW); JIN SHENG LIN, TAOYUAN COUNTY (TW); YI-JUI LEE, TAIPEI CITY (TW); YOU-HAO LIU, TAOYUAN COUNTY (TW); CHUN FONG LIOU, NEW TAIPEI CITY (TW); GUAN-HONG CHEN, NEW TAIPEI CITY (TW)

(72) Inventors: HSIN-CHIA FU, HSINCHU CITY (TW); CHENG-LUNG TSENG, HSINCHU COUNTY (TW); YUNG-CHANG TAI, KAOHSIUNG CITY (TW); JIN SHENG LIN, TAOYUAN COUNTY (TW); YI-JUI LEE, TAIPEI CITY (TW); YOU-HAO LIU, TAOYUAN COUNTY (TW); CHUN FONG LIOU, NEW TAIPEI CITY (TW); GUAN-HONG CHEN, NEW TAIPEI CITY (TW)

(73) Assignee: NATIONAL CHIAO TUNG UNIVERSITY, HSINCHU CITY (TW)

(21) Appl. No.: 13/592,688

(22) Filed: Aug. 23, 2012

(30) Foreign Application Priority Data
May 8, 2012 (TW) 101116385

(51) Int. Cl. H04N 7/15

(52) U.S. Cl. 348/14.03; 348/E07.083

(57) ABSTRACT

The present invention provides an interactive video platform system and a method for the same. Users at the client terminals link to the interactive video platform via a browser to participate in video interactivities among the users. The present invention also provides a virtual camera and a virtual transparency to promote the convenience of the users and the quality and efficiency of the interactive video platform system. At the end of video interactivities, a video server of the interactive video platform system edits the information of the video interactivity and stores the information in a central database for reference by users.

### BACKGROUND OF THE INVENTION

1. Field of the Invention

The present invention relates to a web platform technology, particularly to an interactive video platform system and a method for the same.

2. Description of the Related Art

The over-consumption of energy in the past decades causes crises of energy shortage and the greenhouse effect. Men of insight are preaching energy conservation and carbon reduction to relieve the crises. The video conference system is exactly a tool used by sci-tech workers, international businessmen, and government officials to save time and to increase efficiency.

In a video conference, all the attendants must be able to view the discussed documents. In the conventional technology, all the documents are converted into an image format and presented on a medium, i.e. the so-called whiteboard. As the documents are in an image format, they are usually unlikely to be edited or amend instantly. It is normally after the video conference that one of the attendants summarizes all the opinions, modifies the documents, and sends the modified documents to the corresponding personnel for review. Thus, a further video conference is usually held to confirm the modified documents, which is inconvenient and inefficient.

There is another video conference system, which makes the users feel pretty inconvenient because the users cannot use it unless they have installed the software thereof. There is also a video conference system enabling the near-end attendants to amend or delete the contents on the whiteboard. However, the video conference system does not allow the far-end attendants to vary or interpret the contents but only allows them to view the contents. Thus, there is no means to interact between the near-end and far-end users except oral communication.

Therefore, the present invention proposes an interactive video platform system and a method for the same to overcome the abovementioned problems. The principles and embodiments thereof will be described in detail below.

### SUMMARY OF THE INVENTION

The primary objective of the present invention is to provide an interactive video platform system and a method for the same, wherein the documents, which are to be studied and discussed interactively, are transmitted in form of video information, and wherein all the users can view the latest version of text and figures without converting the documents into image files.

Another objective of the present invention is to provide an interactive video platform system and a method for the same, which use software to overlay a virtual transparency on a monitor, or a displaydevice of every party to enable the users to highlight focuses of documents via writing, drawing or marking, whereby the users can fast grasp the focuses of the topic.

Yet another objective of the present invention is to provide an interactive video platform system and a method for the same, wherein the user can instantly modify the uploaded and displayed document as long as all the users have reach a conclusion, and wherein the modifying, process and the modified document are instantly transmitted to all the users, whereby the users can express their opinions in realtime and quickly settle the contents of the modified documents, wherefore the users are exempted from an additional conference for confirming the modified documents, and wherefore is saved time and promoted efficiency.

A further objective of the present invention is to provide an interactive video platform system and a method for the same, which are implemented by a web browser, whereby the users of the client terminals can enjoy the function of video conferences without installing any special commercial software.

To achieve the abovementioned objectives, the present invention proposes an interactive video platform system, which comprises an interactive video platform, wherein a plurality of users can respectively link to the interactive video platform from their client terminals through a network, and wherein the interactive video platform stores and processes the information coming from each client terminal and distributes the information to all client terminals. The interactive video platform includes a webpage server enabling users to link to the interactive video platform via a browser; a message server transmitting messages for users and sharing messages among users; and an AV (Audio-Video) server receiving AV data from users, transmitting AV data to users, and editing AV data.

The present invention also proposes an interactive video platform method, which comprises steps: a plurality of users using a browser to link to an interactive video platform from the client terminals thereof, and a primary client terminal providing an original document and transmitting to the interactive video platform a piece of information including at least the AV contents of the original document; an AV server of the interactive video platform merging the AV-containing information of the primary client terminal and distributing the AV-containing information to other linked client terminals; installing a virtual transparency software to form a virtual transparency on the AV window of the monitor, or a display device of each client terminal, and one user writing words, drawing figures, or making marks on the virtual transparency to modify or annotate the original document, and then transmitting the words, figures or marks on the virtual transparency to the interactive video platform; a message server of the platform receiving and merging the information of the words, figures and marks coming from the client terminals and transmitting the information to other linked client terminals to present the words, figures and marks; after the video interactivity, the interactive video platform arranging and editing all the information of the video interactivity and storing the information in a central database of the platform for reference by users.

Below, embodiments are described in detail to make easily understood the objectives, technical contents, characteristics and accomplishments of the present invention.

### BRIEF DESCRIPTION OF THE DRAWINGS

FIG. 1 schematically shows an interactive video platform system according to one embodiment of the present invention;

FIG. 2 shows a flowchart of a method for an interactive video platform system according to one embodiment of the present invention; and

FIG. 3 schematically shows an application of the present invention.

### DETAILED DESCRIPTION OF THE INVENTION

The present invention proposes an interactive video platform system and a method for the same, wherein the documents are instantly transmitted to the computers of all users of the interactive video platform system in form of video information, and wherein the documents that are to be transmitted needn't be transformed into image files beforehand, and wherein all the users can share the latest versions of text and pictures in realtime as if they held a face-to-face meeting, and whereby is save time. In the present invention, every user can express his opinions via writing, drawing or marking on a virtual transparency. Thus, the amendment of text or figures can be settled in a single interactive video conference. Therefore is save time and increased efficiency.

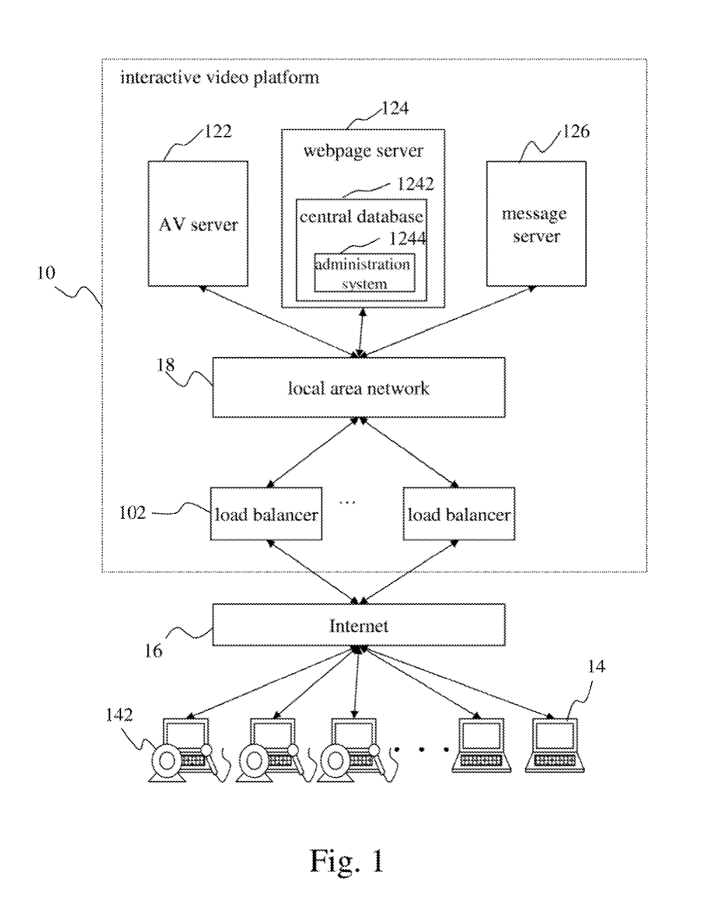

Refer to FIG. 1 schematically showing an interactive video platform system according to one embodiment of the present invention. The system comprises an interactive video platform 10 and a plurality of client terminals 14. The users of the client terminals 14 can link to the interactive video platform 10 through a network 16, such as the Internet. Each client terminal 14 includes a media capture device 142, such as a camera, a webcam, a virtual camera, or a digital camera. The interactive video platform 10 includes an AV server 122, a webpage server 124 and a message server 126, which are linked together by a local area network 18. The interactive video platform 10 processes and stores the information coming from the linked client terminals 14, such as the AV data of the original documents, the words written by the users, figures drawn by the users, and the marks made by the users. The interactive video platform 10 further shares the AV data among the linked client terminals 14. The AV server 122 receives, edits, and transmits the AV data of the linked users. The AV data is in form of an AV streaming. The AV server 122 can store and edit various AV data generated by the users of the client terminals 14, such as movie files or the images and sounds captured by the media capture device 142. The AV server 122 further converts the dynamic or static AV data into an AV streaming and transmits the AV streaming to other linked client terminals 14. The webpage server 124 enables the users to link to the interactive video platform via browser, such as the Internet Explorer, the Netscape, the Chrome, or the FireFox. The message server 126 shares the interactive information (such as the dialog) among all the linked users and monitors the statuses of the users of the linked client terminals 14 of the interactive video platform 10.

The webpage server 124 includes a central database 1242 and an administration system 1244. The webpage server 124 stores and administrates the information input into the interactive video platform 10, such as the AV files of original documents, words, figures and marks, dialogs, and register information. The message server 126 communicates with the central database 1242 via the local area network 118.

The interactive video platform 10 further comprises a load balancer 102. When the load of one of the servers of the interactive video platform 10 approaches the upper limit thereof, the load balancer 102 adds a new AV server 122, webpage server 124 or message server 126 to the interactive video platform 10 according to requirement to promote the performance of the interactive video platform 10. When one of the servers of the interactive video platform 10 fails, the load balancer 102 redistributes the linked client terminals 14 to the other normal servers to avoid link failure of links and maintain stability of service. Therefore, the present invention can satisfy the requirements of network system design: flexibility, robustness and cost efficiency.

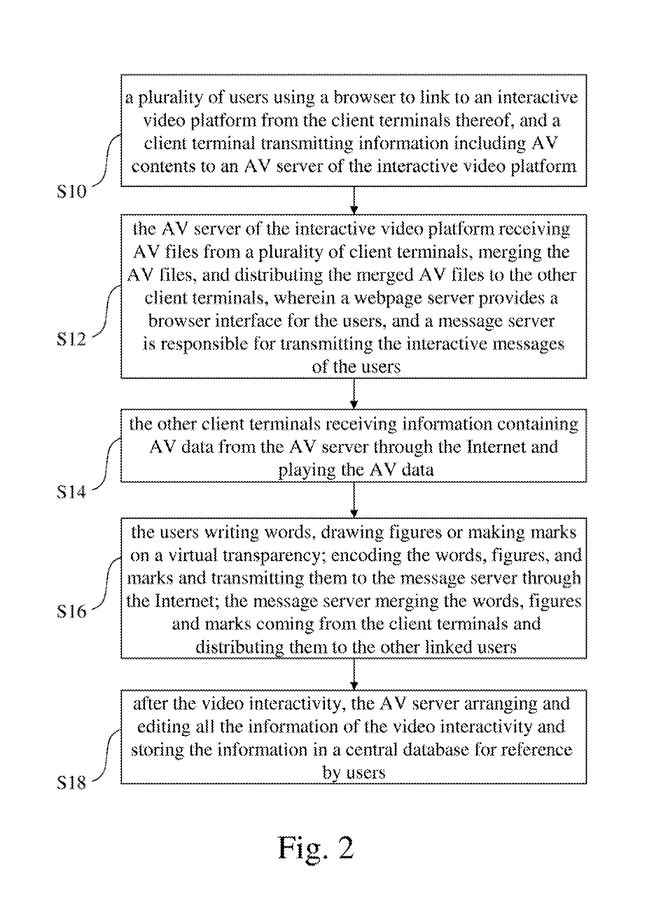

Refer to FIG. 2 showing a flowchart of a method for an interactive video platform system according to one embodiment of the present invention. In Step S10, a plurality of users use a browser to link to an interactive video platform from the client terminals thereof, and a primary client terminal provides the information including at least the AV contents of an original document and transmits the information to an AV server of the interactive video platform, wherein a virtual media capture device is used to generate an image or a video file of the original document, and the image or the video file is transmitted in form of an AV streaming. In Step S12, after receiving the AV file from the primary client terminal, the AV server of the interactive video platform merges the AV file and distributes the merged AV file to the other client terminals, wherein a webpage server of the interactive video platform provides a browser interface for the users, and a message server of the interactive video platform is responsible for transmitting the interactive messages of the users. In Step S14, the other client terminals receive information including the AV file through the Internet and display the AV file, whereby the users of other client terminals can share the AV file of the original document and hear the voices of multiple parties, and whereby a discussion can be undertaken. In Step S16, after receiving the AV file of the original document of the primary client terminal, the users of the other client terminals may write words, draw figures or make marks on a virtual transparency, which overlays a monitor, or a display device and is implemented by software, to annotate or amend the original document that is shown on a window presented in the monitor or the display device. The words, figures, and marks are encoded and then transmitted to the message server through the Internet. The message server merges the words, figures and marks coming from the client terminals and distributes them to the linked users. The media capture devices capture the words, figures and marks, which are generated by users in their client terminals, convert them into image files, and then send them out. In Step S18, after the video interactivity, the AV server arranges and edits all the information of the video interactivity and stores the information in a central database of the platform for reference by users.

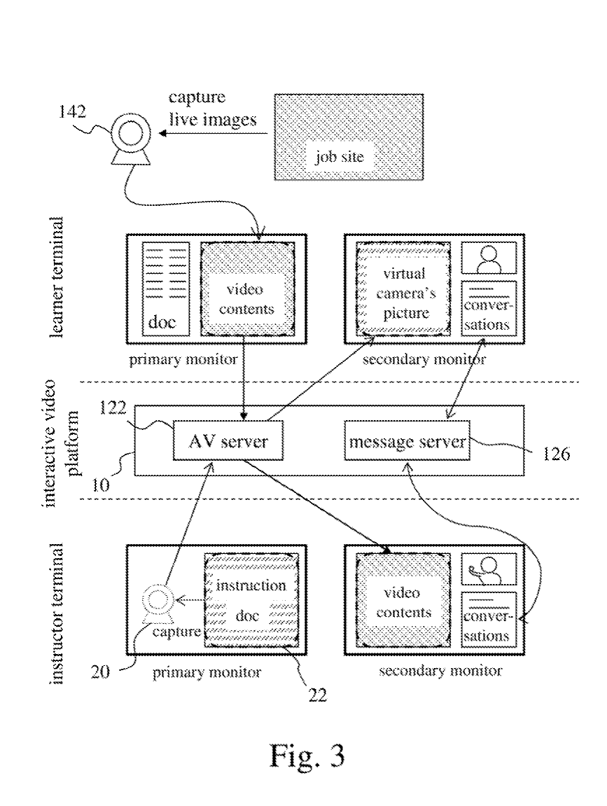

Refer to FIG. 3 for an application of the present invention, wherein a far-end instructor instructs a learner how to maintain a machine. Firstly, the instructor and the learner both link to the interactive video platform and respectively switch on their primary monitors and secondary monitors. The primary monitors respectively display their own original documents and AV information. The secondary monitors respectively display the AV information, mug shots and speeches of their opposite parties. The learner uses a media capture device 142 to take a live image or video of a machine. The live image is presented on the primary monitor of the learner side and converted into an AV streaming. Through the internet, the learner terminal transmits the AV streaming to the AV server 122, and the AV server 122 further transmits the AV streaming to the instructor terminal. Then, the AV information is presented on the secondary monitor of the instructor terminal. Thereby, the instructor can survey the machine and instruct the learner. Suppose that the instructor has reference data (or instructive documents) for the learner. A virtual camera 20 (implemented by software) will convert the reference data into an AV streaming, no matter what type of format the reference data has. The AV streaming is transmitted to the AV server 122, and the AV server 122 then transmits the AV streaming to the learner terminal. As shown in FIG. 3, the image of the instructor's document, which is taken by the virtual camera 20, is presented on the secondary monitor of the learner terminal. A virtual transparency 22 (denoted by a dotted frame) is superimposed on the image of every AV data, whereby both the instructor and the learner can write words, draw figures or make marks on the images of the AV data to prompt the opposite party to observe the focuses. If a single AV window is insufficient to display all the information, the linked parties can open more AV windows, depending on the requirement and the available equipments. Thus, the linked parties can enjoy the instruction as if they were in a live meeting. When the users using different languages are unable to interact orally, the interactive video platform further provides a multi-linguistic dialog window for the users and uses the message server 126 to transmit conversational text. Thereby, the experts of the entire world can provide helps for the user as long as the user links to the interactive video platform. Therefore is greatly expanded the service scope of the interactive video platform.

In the present invention, the text, images and figures are all transmitted in form of video data. Especially, the original document is captured by a virtual camera and transmitted in form of AV data. The other parties, who receive the AV-formatted original document, cannot directly alter the original document but can only annotate the original document via writing words, drawing figures, or making marks on the virtual transparency. Only the user who provides the original document can modify the document-formatted original document in the computer of the client terminal. The other users can view the modification process via the virtual camera. In the present invention, all the users can propose their opinions, but only one user can modify the original document. Therefore, the modification would not be cluttered but will be more orderly.

In conclusion, the present invention proposes an interactive video platform system and a method for the same, which not only use a camera to transmit pictures of human beings and physical entities but also use a virtual camera to transmit text, images and drawings directly in form of video information, whereby the data needn't be converted into image files, and wherefore is accelerated the speed that the data is presented on the screens of the client terminals. Further, data of images and documents are modified in realtime, and the users can view the modification process and the modified contents simultaneously. Therefore, the modified contents can be settled in a single conference, and the users are exempted from an additional conference for confirming the modified contents. Furthermore, the users needn't install special software into their computers but can directly use a conventional browser to link to the interactive video platform system of the present invention. Therefore, the system of the present invention is easy to learn and easy to operate.

The embodiments described above are only to exemplify the present invention but not to limit the scope of the present invention. Any equivalent modification or variation according to the spirit or characteristic of the present invention is to be also included within the scope of the present invention.

What is claimed is:

1. An interactive video platform system comprising
an interactive video platform, wherein a plurality of users respectively links to said interactive video platform from their own client terminals through a network to participate in video interactivities among said users, and wherein said interactive video platform further comprises:
at least one webpage server enabling said users to link to said interactive video platform via a browser;
at least one message server transmitting messages for said users and sharing among said messages among said users, wherein said messages include conversations, written words, drawn figures, and marks; and
at least one audio-video (AV) server receiving AV data from said users, transmitting AV data to said users, editing AV data, and storing AV data.

2. The interactive video platform system according to claim 1, wherein said webpage server thriller comprises a central database storing a plurality of types of information input into said interactive video platform system, including written words, drawn figures, conversations, and registering data.

3. The interactive video platform system according to claim 1, wherein said webpage server further comprises an administration system administrating information of said interactive video platform, including written words, drawn figures, conversations, marks, and registering data.

4. The interactive video platform system according to claim 1, wherein said message server monitors statuses of users of said interactive video platform.

5. The interactive video platform system according to claim 2, wherein said message server communicates with said central database.

6. The interactive video platform system according to claim 1, wherein said AV data is stored in said AV server.

7. The interactive video platform system according to claim 1 further comprising at least one load balancer, which automatically adds at least one new server to said interactive video platform when load of said interactive video platform approaches an upper limit thereof.

8. The interactive video platform system according to claim 1, wherein each said client terminal further comprises a media capture device capturing said AV data converting said AV data into an AV streaming, and sending said AV streaming to said AV server.

9. The interactive video platform system according to claim 8, wherein said media capture device is a camera, a webcam, a virtual camera, or a digital camera.

10. The interactive video platform system according to claim 9, wherein said virtual camera is a program to convert dynamic, static, or dynamic plus static contents of a screen of one said client terminal into an AV streaming and transmit said AV streaming to said AV server.

11. The interactive video platform system according to claim 10, wherein after receiving said AV streaming, said AV server converts said NV streaming into a plurality of AV streamings and distributes said AV streamings to other said client terminals.

12. The interactive video platform system according to claim 1, wherein a virtual transparency program is installed in each said client terminal and able to form on a screen displaying AV data a virtual transparency where said user can write words, draw figures and make marks, and wherein said virtual transparency program transmits codes of said words, said figures and said marks to said message server, and wherein said message server merges said codes of said words, said figures and said marks and transmits merged codes to other said client terminals to redisplay said words, said figures and said marks on said virtual transparencies of other said client terminals.

13. A method for an interactive video platform system, which comprises steps:
a plurality of users respectively linking to an interactive video platform from their own client terminals through a network to participate in video interactivities among said users;
using at least one message server or at least one audio-video (AV) server to distribute information of conversational text, images, or AV data to said client terminals and display said information on said client terminals;
forming on an information display window of each said client terminal a virtual transparency where said users can write words, draw figures and make marks; transmitting codes of said words, said figures and said marks to said message server; and
said message server merging said codes of said words, said figures and said marks, transmitting merged codes to other said client terminals, and redisplaying said words, said figures and said marks on said information display windows of other said client terminals.

14. The method for an interactive video platform system according to claim 13, wherein said webpage server further comprises a central database storing a plurality of types of information input into said interactive video platform system, including written words, drawn figures, conversations, marks, and registering data.

15. The method for an interactive video platform system according to claim 13, wherein said webpage server further comprises an administration system administrating information of said interactive video platform, including written words, drawn figures, conversations, marks, and registering data.

16. The method for an interactive video platform system according to claim 13, wherein said message server monitors statuses of users of said interactive video platform.

17. The method for an interactive video platform system according to claim 14, wherein said message server communicates with said central database.

18. The method for an interactive video platform system according to claim 13, wherein said AV data is stored in said AV server.

19. The method for an interactive video platform system according to claim 13 further comprising at least one load balancer, which automatically adds at least one new server to said interactive video platform when load of said interactive video platform approaches an upper limit thereof.

20. The method for an interactive video platform system according to claim 13, wherein each said client terminal further comprises a media capture device capturing said AV data, converting said AV data into an AV streaming, and sending said. AV streaming to said AV server.

21. The method for an interactive video platform system according to claim 20, wherein said media capture device is a camera, a webcam, a virtual camera, or a digital camera.

22. The method for an interactive video platform system according to claim 21, wherein said virtual camera is a program to convert dynamic, static, or dynamic plus static contents of said display windows of one said client terminal into an AV streaming and transmit said AV streaming to said AV server.

23. The method for an interactive video platform system according to claim 22, wherein after receiving said AV streaming, said AV server converts said AV streaming into a plurality of AV streamings and distributes said AV streamings to other said client terminals.

24. The method for an interactive video platform system according to claim 20, wherein a primary client terminal of said client terminals provides an original document, and wherein said media capture device captures an image of said original document, converts said image of said original document into an image file, and transmits said image file to said message server.
